(19) United States
(12) Patent Application Publication
(10) Pub. No.: US 2022/0284785 A1
(43) Pub. Date: Sep. 8, 2022

(54) MULTI-ALERT SECURITY MESSAGING SYSTEM

(71) Applicant: Ryan Brathwaite, Boston, MA (US)

(72) Inventor: Ryan Brathwaite, Boston, MA (US)

(21) Appl. No.: 17/145,391

(22) Filed: Jan. 10, 2021

Related U.S. Application Data
(60) Provisional application No. 62/959,224, filed on Jan. 10, 2020.

(51) Int. Cl. G08B 21/02; H04W 12/69; H04W 12/60; G06F 21/62

(52) U.S. Cl. CPC G08B 21/02; H04W 12/69; H04W 12/66; G06F 21/6245

(57) ABSTRACT

A method disclosing a multi-alert security messaging system is disclosed. The method includes receiving, by a computing system, an authorization request message from a user equipment (UE), the authorization request message including a set of identification credentials, wherein the identification credentials identify a user, a device, and a location. The method includes performing, by the computing system, a validation process via one or more databases, to determine if the identification credentials are valid, and meet an authorization clearance level. The method includes sending, via the computing system an in-session indication, to a host device. The method includes monitoring at the host device an alert trigger from the UE, based on one or more priority values. The method includes sending at least one alert message from the UE, associated with one or more alert triggers to the host device. The method includes alerting a second device of the one or more alert triggers received from the UE.

### CROSS-REFERENCE TO RELATED APPLICATIONS

The present application claims benefit to U.S. Provisional Patent Application No. 62/959,224, which was filed on Jan. 10, 2020. The contents of the above-identified application are incorporated by reference in their entirety as if recited in full herein.

### FIELD OF INVENTION

Example embodiments relate generally to an office security system. Specifically, a system configured with multiple transceivers and operable to communicate with multiple receivers to provide multiple alerts to a host. The security system is dedicated to providing a safe environment for clinicians, therapists and similar medical providers, and consistent communication between an administrator station or security station that is monitored during business hours.

### BACKGROUND OF THE INVENTION

In the mental health field social workers, psychologist, psychiatrist, psychiatric nurse practitioners and license mental health counselors treat patients with various metal health disorders. To complete mental health evaluations and preserve confidentiality providers meet with patients behind closed doors, often times with limited space and access to a means of egress. Often times patients diagnosed various disorders can present with behavioral problems that can cause a dangerous environment for the provider. Not only can a patient present a danger to the provider, they can pose a danger to themselves as well. A provider must assess the patient, identify what best course of action is necessary, while implementing best practice to ensure their own safety as well as that of the patient.

There are many de-escalation techniques that providers are taught to ensure the safety of themselves and their patients. Often times, due to the patients presenting symptoms they are not able to de-escalate safely. When a patient is unable to maintain or regain control the provider is at risk of becoming seriously injured. In addition to risk to the provider, a patient may pose a safety risk to themselves. It is important that a suicidal patient not be left alone in a room as they may access any object to harm themselves. In either scenario, alerting staff to the situation is pivotal. It is important that the provider be able to leave the room and alerting staff if the patient presents a risk to the provider. It is equally important that the provider alert staff if patient is making statements to hurt themselves. It is important that a suicidal patient not be left alone in a room as they may access any object to harm themselves. In some situations, informing the patient, via a provider's actions or words that the provider is concerned for their own safety or for the patient's safety, is not in the best interest of the patient or can cause the patient to become further escalated. Alerting staff without the patient's knowledge is likely the best course of action to ensure the safety or the provider and the patient. Currently, many treatment rooms are not equipped with panic buttons, and those that are, pressing a panic button may cause further escalation.

It is therefore the intent of the present disclosure to solve the aforementioned problems, and issues, by providing a multi-alert security messaging system. The system, as disclosed, is designed to create a secure way of communication between devices to alert administrator or security staff of multiple levels of emergencies and or unsafe difficulties or situations, in a timely and informative manner.

The aspects or the problems and the associated solutions presented in this section are not necessarily approaches that have been previously conceived or pursued. Therefore, unless otherwise indicated, it should not be assumed that any of the approaches presented in this section qualify as prior art merely by virtue of their presence in this section of the application.

### SUMMARY OF THE INVENTION

In order to resolve many of the aforementioned problems, one skilled in the art would appreciate a solution, that in accordance with one aspect of the present invention, a method disclosing a multi-alert security messaging system is disclosed. The system is designed to create a secure way of communication between devices to alert administrator or security staff of multiple levels of emergencies and or unsafe difficulties or situations, in a timely and informative manner.

The method includes receiving, by a computing system, an authorization request message from a user equipment (UE), the authorization request message including a set of identification credentials, wherein the identification credentials identify a user, a device, and a location. The method further includes performing, by the computing system, a validation process via one or more databases, to determine if the identification credentials are valid, and meet an authorization clearance level. The method includes sending, via the computing system an in-session indication, to a host device. The method further includes monitoring at the host device an alert trigger from the UE, based on one or more priority values. Additionally, the method includes sending at least one alert message from the UE, associated with one or more alert triggers to the host device. The method includes alerting a second device of the one or more alert triggers received from the UE.

In one embodiment, the at least one alert message includes information regarding each of the one or more alert triggers.

In one embodiment, the method can further include receiving, by the computing system, an authorization request message from the host device, the authorization request message including a set of identification credentials.

In one embodiment, there can be a step of determining, by the computing system, priority values corresponding to the one or more alert triggers satisfied by the transaction.

In one embodiment, there can be a step of determining, by the computing system, a priority of the multiple alert triggers based on the priority values corresponding to the one or more alert triggers.

In one embodiment, there can further be a step of generating, by the computing system, one or more alert messages based on the priority of the one or more alert triggers to send to one or more additional user equipments (UEs).

In one embodiment, the priority value for each of the alert triggers is predetermined by an issuer.

In one embodiment, there can be a step of tracking each of the one or more alert triggers, and storing the priority values of each of the one or more alert triggers in a storage.

In one embodiment, the one or more alert triggers includes a set of identification information including one or more of a location-based value, a time of day-based value, a room number value, a user identification value, an alert level value and a threshold value.

In one embodiment, the computing system is coupled to a processing network having an enrollment database in the storage, that contains a list of account identifiers enrolled in the computing system.

In one embodiment, the authorization request message is received by the computing system in response to the processing network determining a matching account identifier.

In one embodiment, the authorization request message includes one or more of a username, a password, a user ID, and a location.

In one embodiment, the one or more alert triggers indicate one or more indications selected from call my phone, knock on door, help emergency, and cancel request.

In one embodiment, there can be a host device. The host device can be configured to access one or more active session relating to a plurality of user equipments (UEs). The host device can further be configured to send a request to a user in possession of one of the plurality of UEs. The host device can further be configured to receive a notification from one of the plurality of UEs. The host device can further be configured to sound an alarm. The host device can further be configured to determine security compliance based on one or more of a predetermined security values and the Health Insurance Portability and Accountability Act (HIPAA). The host device can further be configured to communicate with one or more emergency alert services.

Additionally, a for multi-alert security messaging, is disclosed. The system can receive, an authorization request message from a user equipment (UE), the authorization request message including a set of identification credentials. The system can perform, by the computing system, a validation process via one or more databases, to determine if the identification credentials are valid, and meet an authorization clearance level. The system can send, via the computing system an in-session indication, to a host device. The system can monitor at the host device an alert trigger from the UE, based on one or more priority values. The system can send at least one alert message from the UE, associated with one or more alert triggers to the host device. The system can alert a second device of the one or more alert triggers received from the UE.

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of a multi-alert security messaging system. The accompanying figures are included to provide a further understanding of the invention, and are incorporated in and constitute a part of this specification. The figures illustrate embodiments of the invention and, together with the description, serve to explain the principles of the invention.

The foregoing and other objects, aspects, features, and advantages of the disclosure will become more apparent and better understood by referring to the following description taken in conjunction with the accompanying drawings, in which:

FIG. 1 depicts a process flow of the multi-alert security messaging system, in accordance with an example;

FIG. 2 depicts an example user interface configured with multiple alerts to be transmitted in the security messaging system, in accordance with an example;

FIG. 3 depicts an in-session user interface configured to start or stop a session timer and transmit an in-session signal, in accordance with an example;

FIG. 4 depicts another example of an in-session user interface configured to start or stop a session timer and transmit an in-session signal, in accordance with an example;

FIG. 5 depicts a communication network, in accordance with an example; and

FIG. 6 depicts illustrates a diagram of a wireless device (e.g., UE), in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention.

Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required.

The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The detailed description set forth below in connection with the appended drawings is intended as a description of the presently contemplated embodiments of the multi-alert security messaging systems, and is not intended to represent the only form in which the disclosed invention may be developed or utilized. The description sets forth the various functions and features in connection with the illustrated embodiments. It is to be understood, however, that the same or equivalent functions may be accomplished by different embodiments that are also intended to be encompassed within the scope of the present disclosure.

It is further understood that the use of relational terms such as first and second, top and bottom and the like are used solely to distinguish one from another entity without necessarily requiring or implying any actual such relationship or order between such entities.

All the terminologies and techniques mentioned herein are not particular to any specific embodiment, and it does not scale down different personifications of our invention. Use of words like “and/or” herein includes all the associated listed items and holds all the combinations of different embodiments. Use of singular form of words like “a/an/the” also associate their plural forms into the context unless otherwise clearly defined for their singular meaning.

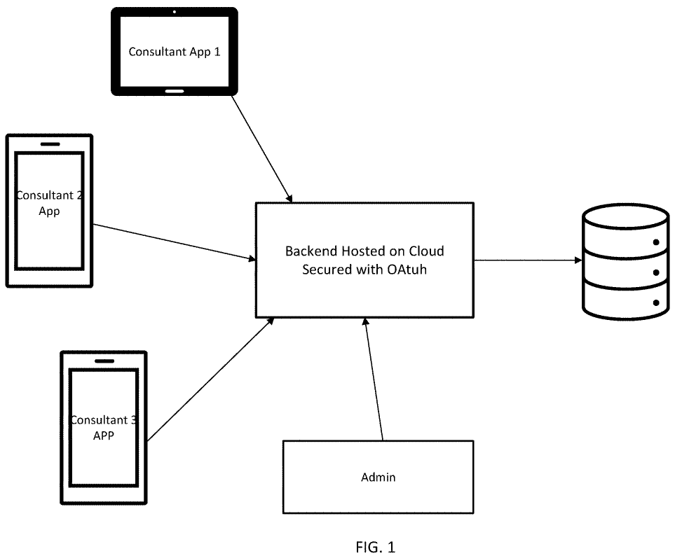

Referring to FIG. 1, which depicts a process flow of the multi-alert security messaging system. A method disclosing a multi-alert security messaging system is disclosed. The system is designed to create a secure way of communication between devices to alert administrator or security staff of multiple levels of emergencies and or unsafe difficulties or situations, in a timely and informative manner. The system can comprise of one or more UEs that are configured with transceivers that allow for one or more users to communicate via network. Each of the UEs are configured to communicate with one or another to synchronously connect to the host device. Additionally, the host device is configured to be hosted on a cloud-based server, that is secured by an open protocol to allow secure authorization (OAuth). Through this secure connection the host device is connected to a storage device or database, where username and password credentials or other identifying credentials are verified and stored.

Additionally, patient information, or client information can be stored on the storage device in order to be easily accessed by an admin (administrator) in connection with, or in possession of the host device. The administrator is configured with the ability to login to the user interface or software with a username and password. The backend in communication with the host device, performs a validation process to determine if the user is accessing from the authorized office internet protocol (IP) address. Upon confirmation and validation of the username and password, the administrator is provided with access to the backend hosted cloud server.

In one embodiment, each of the users of the one or more UEs can be provided access to a user interface or software platform configured to be in communication with the host device. In a preferred embodiment, each of the UEs are configured to communicate with the host device wirelessly. The user interface provides users the ability to login to the user interface using a username and password, and access all of the patient or client session that have been predetermined or stored on the user's schedule or calendar.

Accordingly, in one embodiment, the computing system is configured to receive an authorization request message from a user equipment (UE). The authorization request message is configured to include a set of identification credentials, wherein the identification credentials are configured to identify a user, a device, and/or a location. The computing system can further perform a validation process via one or more databases, to determine if the identification credentials are valid, and meet an authorization clearance level. The authorization clearance level can be predetermined by the administrator to be a level suitable for the role the user is responsible for with an organization.

The system can then send an in-session indication, to a host device, upon a user selection or activation of a session with a client or patient. The host device, upon receiving the in-session indication, is configured to monitor the device for any additional alerts, messages, or a set of alert triggers from the one or more UEs. Each of the one or more alert triggers are configured with a set of priority values, that are predetermined based on the severity of the alert trigger sent by a user of the one or more UEs. Upon an alert trigger being sent by the user from the one or more UEs, the host device receives the alert and notifies the administrator of the location, the user, and the patient or client currently in session.

A storage location can also be in communication with the system in order to store a plurality of historical records of all messages, and alert triggers sent. Each historical record can include a timestamp, location coordinates, room location, and an associated schedule or event that may be relevant to an alert trigger or request sent.

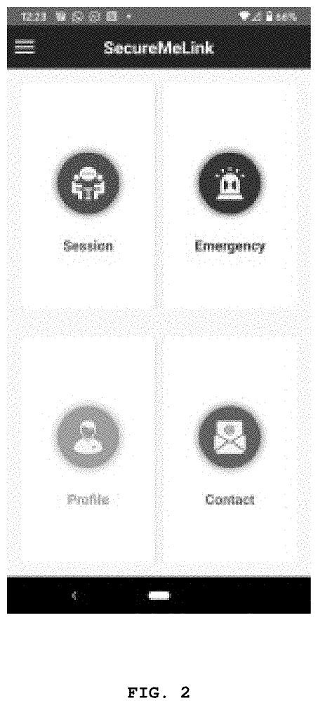

Referring to FIG. 2, the user interface can comprise of several menu options for the user to interact with the user equipment, and send subsequent messages to the host device. A user can select one or more of a session options, a profile option, a contact option, or an emergency option. The session options can be preconfigured to provided manually by a system administrator based on the needs to the organization that is implementing the application and system. This session options that are utilized can be include different levels of access, as well as additional options that may be associated to job function. For example, a managing user may have access to additional identification information related to the user of the additional UE in the overall system, their schedule, clients that they are meeting with, and job function information. An employee user, may only have access to simple functions such as a direct message to a subordinate or manager. Additionally, the employee user may also have an emergency option in order to indicate where there is an escalating situation that needs attention.

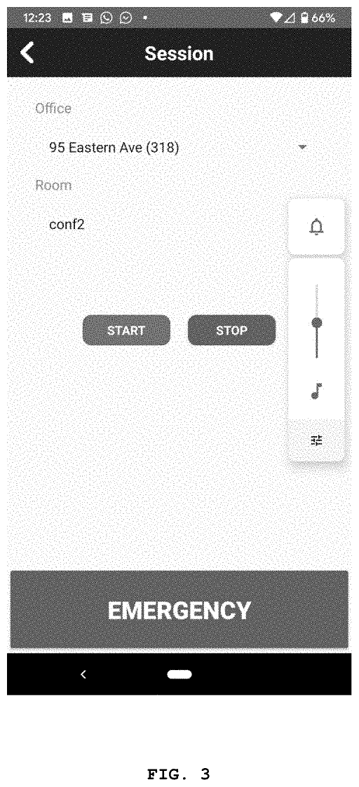

In the instance where the session option is selected, a user can send an indication via the user equipment to the host device, to receive information about the session, or to start or stop an in-session timer and indication, as shown in FIG. 3. The profile option, provides the user or counselor to ability to provide identification information that will allow the administrator to identify who is in possession of the device, the location, and the client that is currently being seen. The contact option, allows a user of the one or more UEs to contact the administrator or other parties in possession of another UE or mobile device. The emergency option provides the user the ability to indicate when there is an emergency in the client session that needs to be addressed.

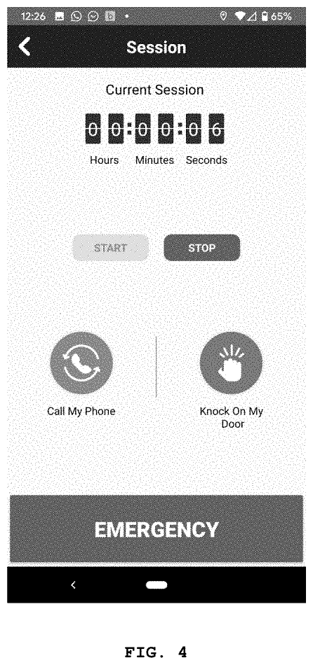

In some instances, as shown in FIG. 4, the user can select the emergency button to indicate to the user interface that additional options need to be selected in order to indicate a de-escalation tactic. The de-escalation options can be selected from one or more of knock on my door, call my phone, emergency or call 911. Each of these options are provided with a priority level in order to indicate to the administrator via the host device, the level of the emergency in the session, and how the emergency needs to be addressed.

The de-escalation options that are provided can be changed or determined based on the relevancy to the organizational structure. This system can be implemented in healthcare institutions, public schools, private schools, private practice, or corporate environments where risk, or various levels of danger could be imminent. The emergency options provided for de-escalation can also be provided a tiered system that allows for different types of de-escalation tactics or requests, via message, based on the current circumstances or event taking place.

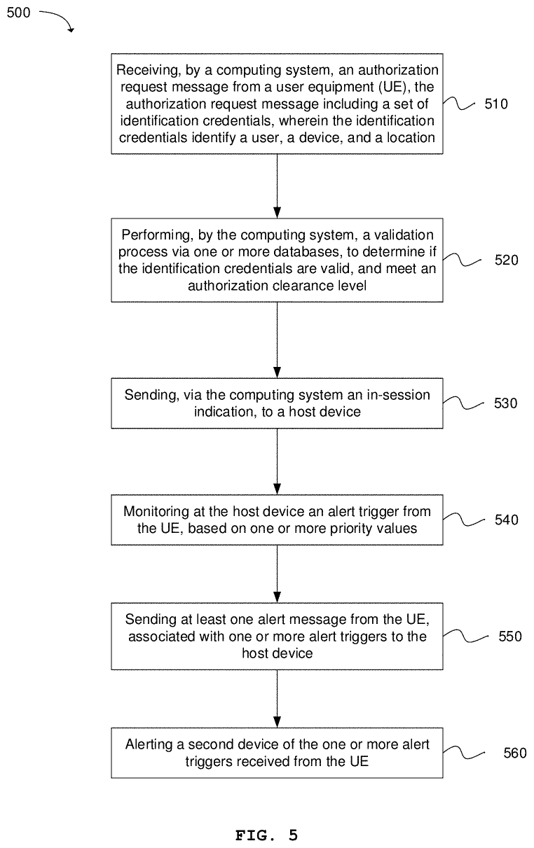

FIG. 5 depicts functionality of a method of a multi-alert security messaging system, hereinafter system, configured to transmit multiple alert triggers. The system can receive, by a computing system, an authorization request message from a user equipment (UE). The authorization request message including a set of identification credentials, wherein the identification credentials identify a user, a device, and a location 510. The system can perform, by the computing system, a validation process via one or more databases, to determine if the identification credentials are valid, and meet an authorization clearance level 520. The system can send, via the computing system an in-session indication, to a host device 530. The system can monitor at the host device an alert trigger from the UE, based on one or more priority values 540. The system can send at least one alert message from the UE, associated with one or more alert triggers to the host device 550. The system can alert a second device of the one or more alert triggers received from the UE 560.

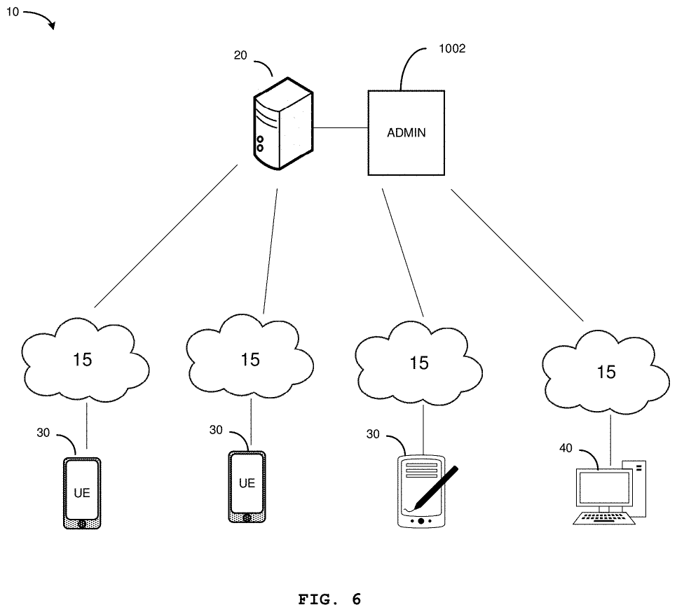

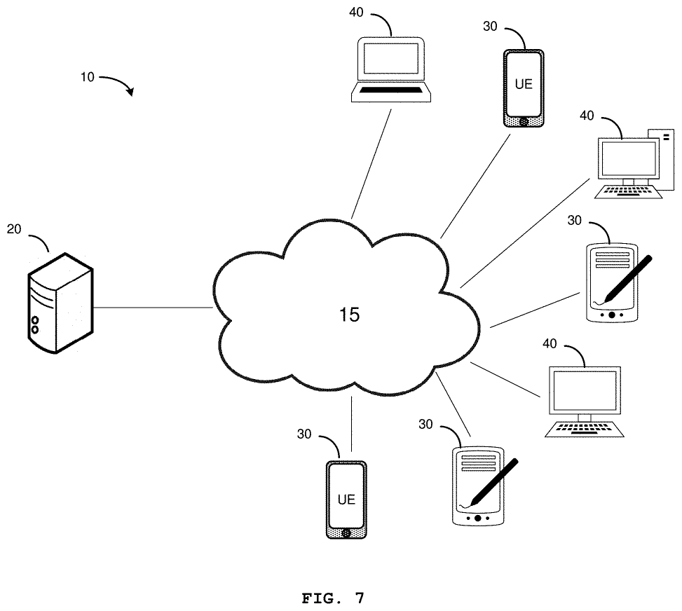

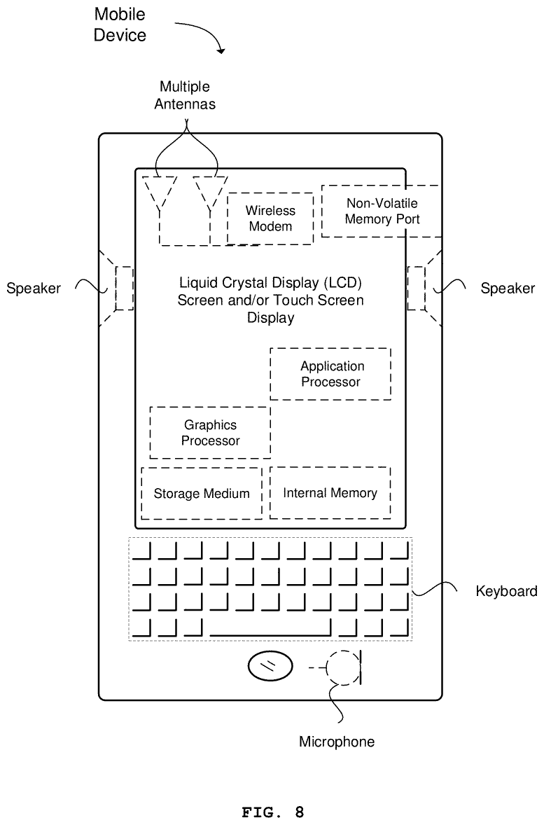

FIG. 6 depicts a messaging network controlled by an administrator 1002, in accordance with an example. In this configuration, an administrator or central office can access the server 20 in order to send an emergency message over the Internet to mobile devices 30 or computers 40 in local networks established within an organizational building. Each computer 40 or mobile device 30 can be connected to one or more personal networks or a central network within an organization's building that are each centrally connected to a server ran by an administrator.

Advantageously, a company may have more than one Administrator 1002 and unlimited users. The Administrator 1002 can organize users by Departments and create unlimited Groups with unlimited members in each group. The Administrator 1002 is also able to access the master message log in the server 20 to filter and analyze sent messages, de-escalation requests, and alert triggers. The logs may be printed or exported in Microsoft Excel™, plain text, or Adobe™ formats, to name just a few examples.

The messaging system described herein may be configured to send an email notification, instant alert, instant message, or a pop-up message to the Administrator 1002, via the administrator UE or device, when an alert trigger or message is sent from a member UE in the system.

Advantageously, the company's administrator 1002, through an administrative service interface, can have access to every message that is sent through the system to and from each employee, or member UE. The log accessible by the administrator shows the message sender, the message recipient(s), the list of the attachments for each message, location from where the message is sent, the alert trigger, de-escalation request and the message text. Each message is encrypted and optionally compressed at a protocol or a technical specialist level. Therefore, the messaging system described herein presents great difficulties for hackers and spammers to launch attacks, decipher a message, or create a false alarm which would inappropriately direct organization resources incorrectly or inconveniently.

FIG. 7 depicts a communication network 10. The communications network can be referring to an internal communications network, an external communicating network, or a network that utilizes both a wireless connection, or a mobile network. The communications network 10 includes a messaging server 20, and several communications devices including mobile devices 30 in the form of a cell phone, a smartphone, and a tablet, and remote computers 40 (such as desktops, laptops, etc.). Each of these devices are capable of communicating with one another either directly or indirectly over a TCP/IP intelligent network 15. The TCP/IP network can also be a cloud-based network. The server 20 has a processor that is under control of software that configures server 20 as a messaging engine. References to the server 20 is intended for the sake of simplicity of description to cover server 20 as an operational unit, including the various server applications and other applications controlling the processor on server 20.

The server 20 is capable of receiving messages sent via Web browsers or mobile applications from a respective user equipment or device over an Internet or Intranet connection. One skilled in the art would appreciate that the execution of a system such as this, as provided by any combination of the examples or embodiments described by Applicant, can be used in various environments other than the Internet. Also, various communication channels may be used such as local area network, wide area network, or point-to-point dial up connection. Also, a server system may comprise any combination of hardware or software that can generate application submission in response to the application submission being performed. A client system may comprise any combination of hardware or software that can interact with the server system. These systems may include television-based systems or various other consumer products through which application may be placed.

FIG. 8 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) or wide local network (WLAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 8 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

The method and system described above for establishing a bi-directional communications session and for messaging may be embodied in one or more software applications comprising computer executable instructions executed by the server and other devices. The software application(s) may comprise program modules including routines, programs, object components, data structures etc. and may be embodied as computer readable program code stored on a computer readable medium. The computer readable medium is any data storage device that can store data, which can thereafter be read by a computing device. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion.

Although the present invention has been described in terms of various embodiments, it is not intended that the invention be limited to these embodiments. Modification within the spirit of the invention will be apparent to those skilled in the art.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art. It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A method comprising:
receiving, by a computing system, an authorization request message from a user equipment (UE), the authorization request message including a set of identification credentials, wherein the identification credentials identify a user, a device, and a location;
performing, by the computing system, a validation process via one or more databases, to determine if the identification credentials are valid, and meet an authorization clearance level;
sending, via the computing system an in-session indication, to a host device;
monitoring at the host device an alert trigger from the UE, based on one or more priority values;
sending at least one alert message from the UE, associated with one or more alert triggers to the host device; and
alerting a second device of the one or more alert triggers received from the UE.

2. The method of claim 1, further comprising:
receiving, by the computing system, an authorization request message from the host device, the authorization request message including a set of identification credentials.

3. The method of claim 1, wherein the at least one alert message includes information regarding each of the one or more alert triggers.

4. The method of claim 1, further comprising:
determining, by the computing system, priority values corresponding to the one or more alert triggers satisfied by the transaction;
determining, by the computing system, a priority of the multiple alert triggers based on the priority values corresponding to the one or more alert triggers; and
generating, by the computing system, one or more alert messages based on the priority of the one or more alert triggers to send to one or more additional user equipments (UEs).

5. The method of claim 1, wherein the priority value for each of the alert triggers is predetermined by an issuer.

6. The method of claim 1, further comprising:
tracking each of the one or more alert triggers; and
storing the priority values of each of the one or more alert triggers in a storage.

7. The method of claim 1, wherein the one or more alert triggers includes a set of identification information including one or more of a location-based value, a time of day-based value, a room number value, a user identification value, an alert level value and a threshold value.

8. The method of claim 1, wherein the computing system is coupled to a processing network having an enrollment database in the storage, that contains a list of account identifiers enrolled in the computing system.

9. The method of claim 8, wherein the authorization request message is received by the computing system in response to the processing network determining a matching account identifier.

10. The method of claim 8, wherein the authorization request message includes one or more of a username, a password, a user ID, and a location.

11. The method of claim 1, wherein the one or more alert triggers indicate one or more indications selected from call my phone, knock on door, help emergency, and cancel request.

12. The method of claim 1, wherein the host device is configured to:
access one or more active session relating to a plurality of user equipments (UEs);
send a request to a user in possession of one of the plurality of UEs;
receive a notification from one of the plurality of UEs;
sound an alarm;
determine security compliance based on one or more of a predetermined security values and the Health Insurance Portability and Accountability Act (HIPAA); or
communicate with one or more emergency alert services.

13. A system for multi-alert security messaging, the system comprising:
receiving, an authorization request message from a user equipment (UE), the authorization request message including a set of identification credentials;
performing, by the computing system, a validation process via one or more databases, to determine if the identification credentials are valid, and meet an authorization clearance level;
sending, via the computing system an in-session indication, to a host device;
monitoring at the host device an alert trigger from the UE, based on one or more priority values;
sending at least one alert message from the UE, associated with one or more alert triggers to the host device; and
alerting a second device of the one or more alert triggers received from the UE.

14. The system of claim 1, wherein the identification credentials identify a user, a device, and a location.

15. The system of claim 1, wherein the UE is configured to display a user enabled mobile application.

16. The system of claim 15, wherein the mobile application comprises of a web-based service accessed by the user through the Internet.

17. The system of claim 15, wherein the mobile application is configured to send a plurality of messages to one or more other user equipments (UEs), the plurality of messages including one or more alerts.

18. The system of claim 17, wherein the one or more alert triggers indicate one or more indications selected from call my phone, knock on door, help emergency, and cancel request.

19. The system of claim 13, further comprising a physical memory storing instruction and the one or more alert triggers.

20. The system of claim 19, wherein the memory is configured to:
receive a request from the UE for the one or more alert triggers or location information of a mobile device amongst a plurality of mobile devices, submitting the one or more alert triggers;
authenticate the request from the UE as being from a UE that is subscribed to the system as a result of an authorization clearance level being met; and
transmit the one or more alert triggers or location information to the UE.
